(19) United States
(12) Patent Application Publication
(10) Pub. No.: US 2022/0307595 A1
(43) Pub. Date: Sep. 29, 2022

(54) HYDRAULIC CIRCUIT ARCHITECTURE WITH ENHANCED OPERATION EFFICENCY

(71) Applicant: Danfoss Power Solutions II Technology A/S, Nordborg (DK)

(72) Inventors: Avinash Amboji, Hadapsar Pune (IN); Suhas Dhakate, Yerwada Pune (IN); Mohammedsaeed Inamdar, Ghorpadi Pune (IN); Shashishekar Ms, Maharashtra (IN)

(21) Appl. No.: 17/606,104

(22) PCT Filed: Apr. 24, 2020
(86) PCT No.: PCT/EP2020/025188

§ 371 Date: Oct. 25, 2021

(30) Foreign Application Priority Data
Apr. 26, 2019 (IN) 201911016747

(51) Int. Cl. F16H 61/431; F15B 11/17; F15B 13/02; F15B 15/18; F16H 61/452; F16H 61/4035; F16H 61/4157; B60W 10/18; B60W 10/08; B60W 10/30; B60W 30/188; B60W 30/18; B60P 3/16; F16H 61/47; F16H 61/4148; F16H 61/4008; B28C 5/42

(52) U.S. Cl. CPC F16H 61/431; F15B 11/17; F15B 13/024; F15B 15/18; F16H 61/452; F16H 61/4035; F16H 61/4157; B60W 10/18; B60W 10/08; B60W 10/30; B60W 30/188; B60W 30/18127; B60P 3/16; F16H 61/47; F16H 61/4148; F16H 61/4008; B28C 5/4213; B28C 5/4227; F15B 2211/50518

(57) ABSTRACT

The present disclosure relates to a hydraulic drive system having a hydraulic circuit architecture operable in first and second modes. In a first mode, a main hydraulic pump (22) is used to drive a hydraulic actuator (24) via a closed hydraulic circuit, and a charge pump (42) provides charge flow to the closed hydraulic circuit. In a second mode the main pump set to zero displacement and the charge pump (42) is used to drive the hydraulic actuator (24).

### CROSS-REFERENCE TO RELATED APPLICATION

This application is a National Stage application of International Patent Application No. PCT/EP2020/025188, filed on Apr. 24, 2020, which claims priority to Indian Application No. 201911016747 filed on Apr. 26, 2019, each of which is hereby incorporated by reference in its entirety.

### TECHNICAL FIELD

The present disclosure relates generally to architectures for hydraulic systems. More particularly, the present disclosure relates to hydraulic systems having closed circuit hydraulic architectures.

### BACKGROUND

Machines such as vehicles, for example, skid steer vehicles and transit mixers, often have closed circuit hydraulic systems (e.g., hydrostatic transmissions). In the case of skid steer vehicles, closed circuit hydraulic systems may be used for vehicle propulsion. In the case of transit mixers, closed circuit hydraulic systems may be used to provide concrete drum rotation.

### SUMMARY

Closed circuit hydraulic systems can be used for applications in which the systems are operated at low flow conditions to drive actuators at slower speeds, and high flow conditions to drive actuators at higher speeds. For some of these systems, such as a system for rotating a concrete drum for a transit mixer, the duration the system is operated at a low flow condition is much longer than the duration the system is operated at a high flow condition. During such low flow operations, a main pump of the system is operated at a reduced stroke length to provide reduced hydraulic fluid flow through the closed circuit. Prolonged operation at low speeds is not ideal from an efficiency perspective since variable piston pumps exhibit lower volumetric efficiencies when operated at reduced stroke lengths. In the case of a transit mixer, considerable energy losses result. Aspects of the present disclosure relate to architectures for addressing this issue.

During higher speed operation of a closed circuit hydraulic system, the main pump operates at full stroke and the charge pump is loaded by hot oil relief pressure. The hot oil relief valve is set at a pressure greater than the control pressure required for changing the displacement of the main pump, and energy losses proportional to the pressure margin will occur whenever the system is in use. Further, during idling operation of a closed circuit hydraulic system, the charge pump flow typically relieves over a charge pump relief valve causing energy losses the magnitude of which depends upon the relief setting of the charge pump relief valve. Aspects of the present disclosure relate to systems for reducing these types of losses.

Aspects of the present disclosure relate to a closed circuit architecture with intelligent control strategy adapted to allow charge pump flow to be used to satisfy low speed requirements. In this way, a main pump need not be used to satisfy low speed requirements and energy losses related to the inefficient volumetric efficiency of the main pump for low flow applications can be reduced.

Aspects of the present disclosure also relate to a closed circuit architecture with intelligent control strategy adapted to allow real-time pressure regulation of a relief pressure setting of a hot oil relief valve to minimize differences between the relief pressure setting and the pump control pressure during higher flow operation. In this way, energy losses related to the margin between the pump control pressure and the pressure relief setting can be reduced.

Aspects of the present disclosure also relate to closed circuit architecture with intelligent control strategy adapted to allow real-time regulation of a relief pressure setting of a charge pump relief valve to minimize energy losses during idling/no work conditions.

Aspects of the present disclosure also relate to closed circuit architecture with intelligent control strategy adapted to allow for the real-time regulation of a pressure relieve setting of a hot oil relief valve to provide for dynamic braking against equipment inertial movement.

Aspects of the present disclosure also relate to a hydraulic architecture that can switch between a closed loop circuit configuration where a charge pump provides charge flow to a main pump that drives an actuator, and an open loop circuit configuration where the charge pump drives the actuator.

Aspects of the present disclosure relate to a hydraulic circuit architecture for powering a hydraulic actuator such as a hydraulic motor for rotating a concrete drum of a transit mixer. During a first mode of operation, the hydraulic motor is driven at a first speed by hydraulic fluid pumped through a closed loop circuit by a main hydraulic pump powered by a power take-off of an engine. A charge pump, power by an electric motor, provides charge flow to a low-pressure side of the main hydraulic pump. During a second mode of operation, the main hydraulic pump is set to zero displacement, and charge pump is used to drive the hydraulic motor at a second speed that is less than the first speed. In the second mode of operation, the hydraulic circuit architecture is configured as an open loop hydraulic circuit.

Aspects of the present disclosure relate to hydraulic systems having hydraulic circuit architectures having features for enhancing the overall operating efficiencies of the hydraulic systems. One aspect of the present disclosure relates to hydraulic systems having hydraulic circuit architectures including features adapted to enhance the operating efficiencies of the systems during low speed operations. In one example hydraulic system, the hydraulic circuit architecture allows a charge pump to drive a hydraulic actuator of the system during low speed operations. Other examples relate to hydraulic systems having hydraulic circuit architectures that can be operated as closed circuits for high-speed operations, and can be operated as open hydraulic circuits for low speed operations. A further aspect of the present disclosure relates to hydraulic systems having a closed circuit architecture in which a hot oil relief valve of the system can be variably set at different pressures depending upon the control pressure of the system. In certain examples, the oil pressure relief setting of the hot oil relief valve is maintained at a pressure setting only slightly greater than the control pressure of the system. A further hydraulic system in accordance with the principles of the present disclosure utilizes a charge pump relief valve having a variable pressure relief setting in which the pressure relief setting is substantially reduced when the system is operating in an idling condition.

Another aspect of the present disclosure relates to a hydraulic drive system including a main hydraulic pump (e.g., a variable displacement pump or a fixed displacement pump), a hydraulic actuator (e.g., a hydraulic motor, hydraulic cylinder or the like) and a charge pump (e.g., an integral or auxiliary charge pump). The hydraulic system is operable in a first mode in which the main hydraulic pump drives the hydraulic actuator via a closed hydraulic circuit and the charge pump provides charge flow to the closed hydraulic circuit. The hydraulic system is also operable in a second mode in which the charge pump drives the hydraulic actuator via an open hydraulic circuit.

In one example, a hydraulic drive system for driving a vehicle component includes an electric motor, a variable displacement hydraulic pump driven by the electric motor, a variable displacement hydraulic motor driven by the main hydraulic pump, the hydraulic motor having an output shaft for driving the vehicle component, and a controller for controlling the speed of the electric motor and the displacement of the hydraulic pump, the controller being configured to meet an output demand of the hydraulic motor by selecting a combination of motor displacement, pump displacement and motor speed that results in the maximum efficiency of the system.

In some examples, the hydraulic component is one of a rotating drum and a propulsion system of a transit mixer.

In some examples, the controller is configured with a high speed mode and a low speed mode, wherein in the high speed mode the hydraulic motor and pump are operated at full displacement and the speed of the electric motor is varied to meet the output demand of the hydraulic motor.

In some examples, if an efficiency of the electric motor at low speeds is higher than an efficiency of the hydraulic pump at de-stroked conditions, the controller reduces the speed of the electric motor in order to achieve the output demand of the hydraulic motor. In some examples, if an efficiency of the electric motor at low speeds is higher than an efficiency of the hydraulic pump at de-stroked conditions, the controller reduces the speed of the electric motor in order to achieve the output demand of the hydraulic motor.

In some examples, the controller compares a rotational speed of the hydraulic component and compares the rotational speed with a reference speed, wherein the controller stops supply of power to the electric motor when the rotational speed matches the reference speed, wherein the controller supplies power to the electric motor when the rotational speed falls below the references speed.

In one example, a drive system for driving a vehicle component includes a first drive pathway including a hydrostatic transmission, a second drive pathway including an electric motor, a drive interface for transmitting power from the first or second drive pathway to the vehicle component, and a controller for selectively operating the hydrostatic transmission and the electric motor.

In some examples, the vehicle component is a drum of a transit mixer, the drum having a rotational speed demand.

In some examples, when a rotational speed demand of the drum is above a threshold, the controller operates the hydrostatic transmission to supply power to the vehicle component through the drive interface.

In some examples, the electric motor is driven by the hydrostatic transmission through the drive interface and acts as a generator.

In some examples, when a rotational speed demand of the drum is below a threshold, the controller operates the electric motor to supply power to the drum through the drive interface and controls the hydrostatic transmission to destroke at least one of a hydraulic pump and a hydraulic motor of the hydrostatic transmission.

In some examples, the controller compares a rotational speed of the drum and compares the rotational speed with a reference speed, wherein the controller stops supply of power to the electric motor when the rotational speed matches the reference speed, wherein the controller supplies power to the electric motor when the rotational speed falls below the references speed.

In some examples, the vehicle component is a propulsion system of a vehicle, for example a transit mixer, the propulsion system having a speed demand.

In some examples, when a rotational speed demand of the propulsion system is above a threshold, the controller operates the electric motor to supply power to the propulsion system through the drive interface and controls the hydrostatic transmission to destroke at least one of a hydraulic pump and a hydraulic motor of the hydrostatic transmission.

In some examples, when a rotational speed demand of the propulsion system is below a threshold, the controller operates the hydrostatic transmission to supply power to the vehicle component through the drive interface.

In some examples, the controller compares a rotational speed of the propulsion system and compares the rotational speed with a reference speed, wherein the controller stops supply of power to the electric motor when the rotational speed matches the reference speed, wherein the controller supplies power to the electric motor when the rotational speed falls below the references speed.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 schematically depicts a hydraulic drive system having an example hydraulic circuit architecture in accordance with the principles of the present disclosure;

FIG. 2 shows the hydraulic drive system of FIG. 1 being operated in an open-circuit mode suitable for lower speed operations in which a charge pump of the hydraulic drive system is being used to drive a hydraulic motor of the hydraulic drive system;

FIG. 3 depicts the hydraulic drive system of FIG. 1 operating in an idling condition;

FIG. 4 depicts the hydraulic drive system of FIG. 1 operating in a closed-circuit mode suitable for higher speed operations;

FIG. 5 depicts the hydraulic drive system of FIG. 1 operating in the mode of FIG. 2 and with a hot oil relief valve being used to assist in braking against inertial movement of the hydraulic motor;

FIG. 6 depicts an example hydraulic drive system that can utilize hydraulic circuit architectures in accordance with the principles of the present disclosure, the hydraulic drive system controls the delivery of power generated by an electric motor and a combustion engine to a hydraulic motor coupled to a gear box which drives rotation of a concrete drum of a transit mixer;

FIG. 7 is an example controller for controlling operation of the hydraulic system of FIG. 6;

FIG. 8 is another example controller for controlling operation of the hydraulic system of FIG. 6;

FIG. 9 depicts an example drive system that can utilize hydraulic circuit architectures in accordance with the principles of the present disclosure, the hydraulic drive system controls the delivery of power generated by a battery-powered electric motor to the hydraulic drive system to effectuate drum rotation and propulsion of a transit mixer;

FIG. 10 depicts an example drive system that can utilize hydraulic circuit architectures in accordance with the principles of the present disclosure, the drive system includes an engine powering the hydraulic drive system and a parallel drive system with a battery-powered electric motor, wherein a drive interface couples both systems to selectively effectuate drum rotation and/or propulsion of a transit mixer;

FIG. 11 shows a schematic illustrating the determination of which drive system to utilize in the configuration of FIG. 10 where the drive system is utilized for drum rotation; and

FIG. 12 shows a schematic illustrating the determination of which drive system to utilize in the configuration of FIG. 10 where the drive system is utilized for propulsion.

FIG. 13 is a schematic example of a drive interface usable with the configuration shown in FIG. 10.

### DETAILED DESCRIPTION

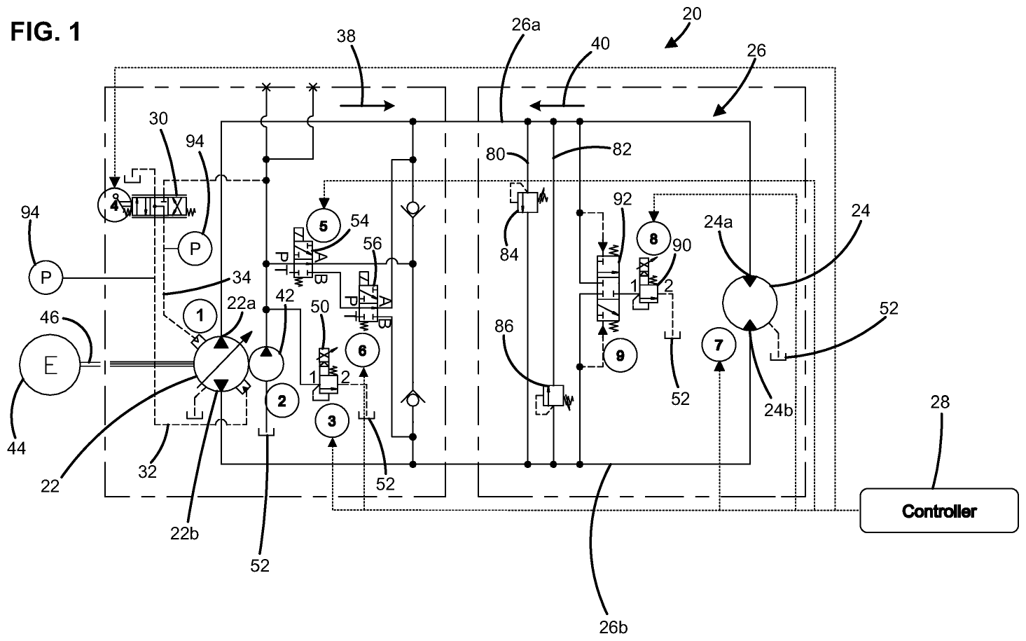

FIG. 1 depicts a hydraulic drive system 20 having a hydraulic circuit architecture in accordance with the principles of the present disclosure. The hydraulic drive system 20 includes a main hydraulic pump 22 for driving a hydraulic actuator such as a hydraulic motor 24. The main hydraulic pump 22 is hydraulically coupled to the hydraulic motor 24 by a closed hydraulic circuit 26. The closed hydraulic circuit 26 includes a first portion 26a that extends from a first port 22a of the main hydraulic pump 22 to a first port 24a of the hydraulic motor 24. The closed hydraulic circuit 26 also includes a second portion 26b that extends from a second port 24b of the hydraulic motor 24 to a second port 22b of the main hydraulic pump 22. It will be appreciated that the first and second portions 26a, 26b can be referred to as first and second flow lines, and cooperate to define the closed hydraulic circuit 26 that extends between the main hydraulic pump 22 and the hydraulic motor 24. It will be appreciated that the first and second ports 22a, 22b of the main hydraulic pump 22 as well as the first and second ports 24a, 24b of the hydraulic motor 24 can be referred to as sides of the main hydraulic pump 22 and/or the hydraulic motor 24.

The main hydraulic pump 22 is preferably a variable displacement, bi-directional pump. The displacement of the main hydraulic pump 22 as well as the direction of hydraulic fluid flow through the closed hydraulic circuit 26 can be controlled by a controller 28. In the depicted example, the controller 28 interfaces with a pump control valve 30 used to control the displacement as well as the pumping direction of the main hydraulic pump 22. In one example, the pump control valve 30 can be actuated by a driver such as a solenoid controlled by the controller 28. The pump control valve 30 can be moved to different positions by the solenoid under the control of the controller 28 to control the displacement and pumping direction of the main hydraulic pump 22. In one example, the pump control valve 30 controls a pump control pressure provided to the main hydraulic pump 22 via pump control lines 32, 34 which provide hydraulic pressure for controlling the position of a swash plate 36. It will be appreciated that the angle of the swash plate 36 controls the displacement and pumping direction of the main hydraulic pump 22.

As indicated above, the main hydraulic pump 22 is preferably bi-directional. Thus, the main hydraulic pump 22 can be operated in a first directional setting in which hydraulic fluid flows in a first direction 38 through the closed hydraulic circuit 26. The main hydraulic pump 22 can also be operated at a second directional setting in which hydraulic fluid is pumped in a second direction 40 through the closed hydraulic circuit 26. When the hydraulic fluid is pumped in the first direction 38, the first portion 26a of the closed hydraulic circuit 26 represents a high-pressure side of the closed hydraulic circuit 26, and the second portion 26b represents a low-pressure side of the closed hydraulic circuit 26. As such, the first port 22a represents a high-pressure side of the main hydraulic pump 22 and the first port 24a represents a high-pressure side of the hydraulic motor 24. In addition, the second port 22b represents a low-pressure side of the main hydraulic pump 22 and the second port 24b represents a low-pressure side of the hydraulic motor 24. By contrast, when the main hydraulic pump 22 pumps hydraulic fluid in the second direction 40 through the closed hydraulic circuit 26, the second portion 26b represents the high-pressure line of the closed hydraulic circuit 26 and the first portion 26a represents the low-pressure line of the closed hydraulic circuit 26. As such, the second port 22b of the main hydraulic pump 22 represents the high-pressure side of the main hydraulic pump 22 and the second port 24b represents the high-pressure side of the hydraulic motor 24. As such, the first port 22a represents the low-pressure side of the main hydraulic pump 22 and the first port 24a represents the low-pressure side of the hydraulic motor 24.

The controller 28 can include one or more processors. The processors can interface with software, firmware, and/or hardware. Additionally, the processors can include digital or analog processing capabilities and can interface with memory (e.g., random access memory, read-only memory, or other data storage). In certain examples, the processors can include a programmable logic controller, one or more microprocessors, or like structures. The processors can also interface with displays (e.g., indicator lights, screens, etc.) and user input interfaces (e.g., control buttons, switches, levers, keyboards, touchscreens, control panels, dials, slide-bars, etc.). The user input interfaces can also a user to input a speed input signal to the controller which is representative of a desired rotational speed of the motor 24. In one example, the motor drives a concrete drum of a transit mixer.

Referring still to FIG. 1, the hydraulic drive system 20 also includes a charge pump 42. The charge pump 42 can be integral with the main hydraulic pump 22 or auxiliary with respect to the main hydraulic pump 22. In the depicted example, the charge pump 42 and the main hydraulic pump 22 are both powered by the same power source 44. The power source 44 can include a combustion engine or an electric motor. In the depicted example, the main hydraulic pump 22 and the hydraulic motor 24 are both mounted on the same shaft 46 which is driven by the power source 44. In other examples, the charge pump 42 and the main hydraulic pump 22 can be powered by different power sources. In one example, the main hydraulic pump 22 is powered by a combustion engine while the charge pump 42 is powered by an electric motor. In other examples, the main hydraulic pump 22 and the charge pump 42 may be driven by separate combustion engines, by separate electric motors, or by a combustion engine and a separate electric motor.

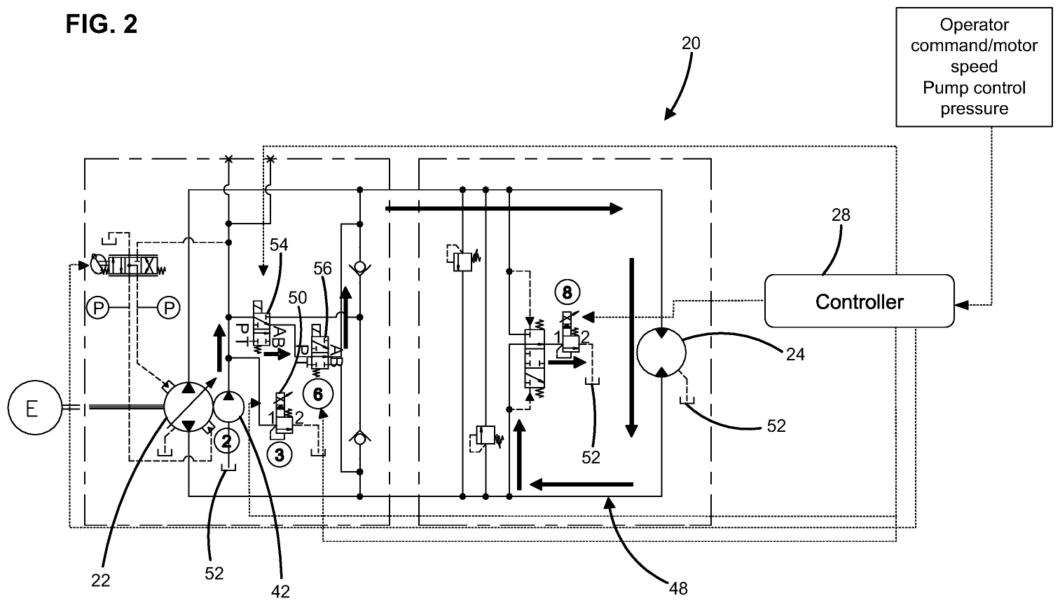

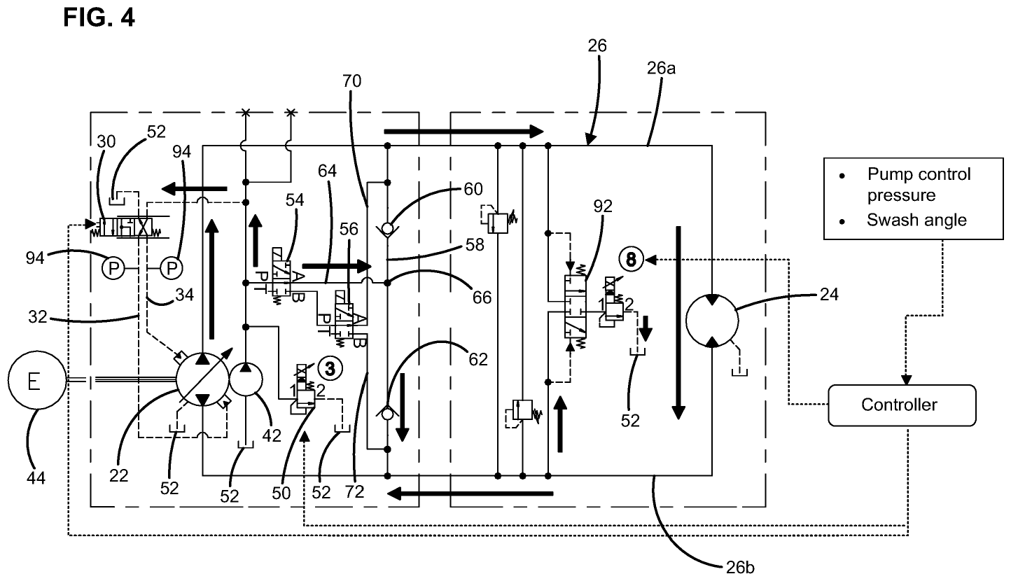

The hydraulic circuit architecture of the hydraulic drive system 20 is preferably configured such that the hydraulic drive system 20 is operable in a first mode (see FIG. 4) in which the main hydraulic pump 22 drives the hydraulic motor 24 via the closed hydraulic circuit 26 and the charge pump 42 provides charge flow to the low pressure side of the closed hydraulic circuit 26. The hydraulic circuit architecture of the hydraulic drive system 20 is also configured such that the hydraulic drive system 20 is operable in a second mode (see FIG. 2) in which the charge pump 42 drives the hydraulic motor 24 via an open hydraulic circuit 48. In one example, when the hydraulic drive system is operated in the second mode of FIG. 2, the main hydraulic pump 22 is set to zero displacement and the charge pump 42 alone drives the hydraulic motor 24 via the open hydraulic circuit 48.

It will be appreciated that the first mode is preferably activated for higher motor speed applications and the second mode is preferably activated for lower motor speed operations. The second mode allows the motor 24 to be efficiently driven at low speeds, while the main pump 22 is de-activated (e.g., set to zero displacement). In this way, the main pump 22 is not required to be used for low flow applications in which its volumetric efficiency is low. However, for higher motor speed applications which require higher hydraulic flow rates, the main pump 22 can efficiently be used to drive the motor 24. The controller 28 can switch the system between the first and second modes based upon the value of a motor speed input signal input to the controller from a user interface. The motor speed input signal corresponds to a desired drive speed of the hydraulic motor 24. If the desired drive speed of the hydraulic motor is above a predetermined speed, the controller 28 can set the system to the first mode. If the desired motor drive speed is at or below the predetermined speed, the controller 28 can set the system to the second mode.

Referring again to FIG. 1, the hydraulic circuit architecture of the hydraulic drive system 20 further includes a first relief valve 50 for limiting an output pressure of the charge pump 42 by fluidly connecting an output side of the charge pump 42 to tank 52 when the output pressure of the charge pump 42 reaches a charge pump relief pressure level. In a preferred example, the first relief valve 50 is a proportional valve in which the charge pump pressure relief setting is automatically controlled/regulated/changed by the controller 28 via a solenoid or other means. The controller 28 can change the pressure relief setting based on the mode of operation of the system and the pressure relief settings can be changed in real time. In other examples, the first relief valve 50 may be manually changed to different pressure relief settings depending upon the mode of operation of the system. The charge pump relief pressure level of the first relief valve 50 is set at a first pressure relief setting when the hydraulic drive system 20 is operated in the first mode and a second pressure relief setting when the hydraulic drive system is operated in the second mode. The second pressure relief setting of the first relief valve 50 is higher than the first pressure relief setting of the first relief valve 50. The second pressure relief setting is preferably high enough to allow the charge pump 42 to effectively drive the hydraulic motor 24 without dumping hydraulic fluid flow to tank 52 through the first relief valve 50.

The hydraulic circuit architecture of the hydraulic drive system 20 further includes a mode selector valve 54 movable between a first position (see FIG. 4) in which the hydraulic drive system 20 is configured such that the charge pump 42 is adapted to provide charge flow to the low pressure side of the closed hydraulic circuit 26, and a second position (see FIG. 2) in which the hydraulic drive system 20 is configured such that the charge pump 42 is adapted to drive the hydraulic motor 24. The hydraulic drive system 20 further includes a flow directional control valve 56 for controlling a direction of hydraulic fluid flow through the hydraulic motor 24 such that the charge pump 42 can selectively drive the hydraulic motor 24 in either the first or second opposite motor directions. The positions of the mode selector valve 54 and the control valve 56 can be automatically controlled by the controller 28 dependent upon the mode of operation of the system and the desired rotational direction of the hydraulic motor 24.

Referring again to FIG. 4, the hydraulic drive system 20 includes a charge pump flow line 58 that extends between the first and second portions 26a, 26b of the closed hydraulic circuit 26. First and second one-way check valves 60, 62 are positioned along the charge pump flow line 58. The first one-way check valve 60 allows flow through the charge pump flow line 58 in a direction toward the first portion 26a of the closed hydraulic circuit 26, but prevents flow through the charge pump flow line 58 in a direction away from the first portion 26a of the closed hydraulic circuit 26. The second one-way check valve 62 allows hydraulic fluid flow through the charge pump flow line 58 in a direction toward the second portion 26b of the closed hydraulic circuit 26, but prevents hydraulic fluid from flowing through the charge pump flow line 58 in a direction away from the second portion 26b of the closed hydraulic circuit 26.

The hydraulic drive system 20 includes a charge flow line 64 that extends from the mode selector valve 54 to a location 66 along the charge pump flowline 58 that is between the first and second one-way check valves 60, 62. The hydraulic drive system 20 also includes a motor drive flow line 68 that extends from the mode selector valve 54 to the flow directional control valve 56. The flow directional control valve 56 can selectively couple the motor drive flow line 68 to a first directional flow control line 70 that couples to the charge pump flow line 58 at a location 71 between the first one-way check valve 60 and the first portion 26a of the closed hydraulic circuit 26, and a second directional flow control line 72 that couples to the charge pump flow line 58 at a location 73 between the second one-way check valve 62 and the second portion 26b of the closed hydraulic circuit 26.

Referring again to FIG. 1, the hydraulic architecture of the hydraulic drive system 20 can also include pressure relief lines 80, 82 that extend between the first and second portions 26a, 26b of the closed hydraulic circuit 26. The pressure relief lines 80, 82 each include a corresponding pressure relief valve 84, 86. The pressure relief lines 80, 82 are configured to allow flow to be relieved in parallel with respect to the hydraulic motor 24 if the pressure within the closed hydraulic circuit 26 exceeds a pressure relief setting of the pressure relief valves 84, 86. In certain examples, the pressure relief setting of the pressure relief valves 84, 86 is set to the maximum operating pressure of the system.

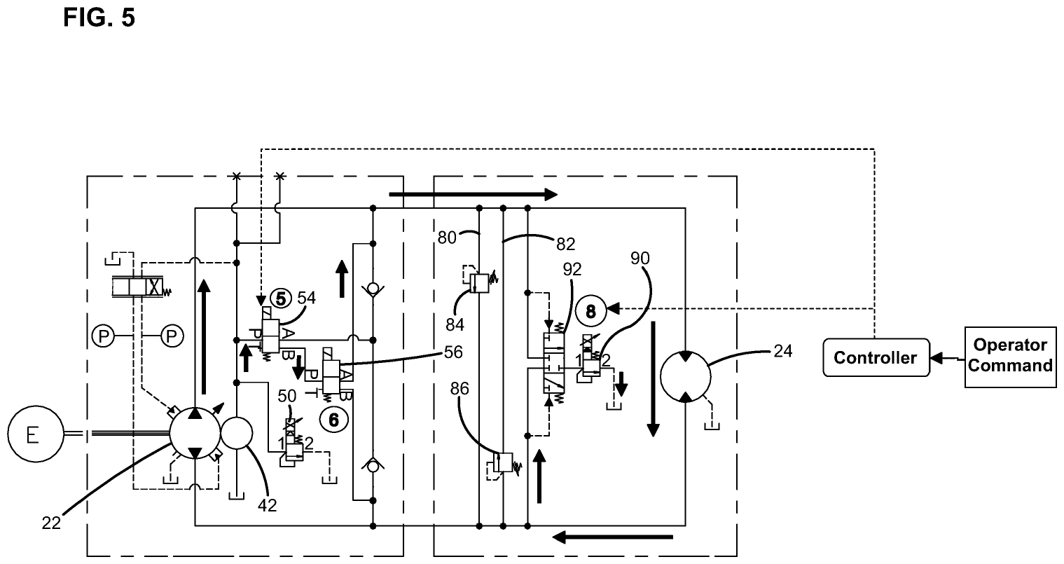

Referring again to FIG. 1, the hydraulic architecture of the hydraulic drive system 20 is depicted as further including a second relief valve 90 adapted to be in fluid communication with a low-pressure side of the hydraulic motor 24 for limiting a hydraulic fluid pressure at the low-pressure side of the hydraulic motor 24. In a preferred example, a pressure relief setting of the second relief valve 90 is controlled (e.g., changed, set) by the controller 28 based on the mode of operation of the system. For example, the second relief valve 90 can be a proportional relief valve the position of which is controlled by a driver such as a solenoid that is controlled in real time by the controller 28. In other examples, the pressure relief setting of the second relief valve 90 can be manually adjustable. The second relief valve 90 is set at a first pressure relief setting when the hydraulic drive system 20 is operated in the first mode and a second pressure relief setting when the hydraulic drive system 20 is operated in the second mode. The first pressure relief setting is higher than the second pressure relief setting. The second relief valve 90 relieves hydraulic fluid from the closed hydraulic circuit 26 to prevent hydraulic pressure within the closed hydraulic circuit from exceeding the first pressure relief setting when the hydraulic fluid within the closed hydraulic circuit thermally expands during operation of the hydraulic drive system 20 in the first mode. The second relief valve 90 allows hydraulic fluid from the low pressure side of the hydraulic motor 24 to bypass the main pump and flow instead to tank 52 when the hydraulic drive system 20 is operated in the second mode. A shuttle valve 92 controls flow between the second relief valve 90 and the closed hydraulic circuit 26. The shuttle valve 92 is configured for connecting the second relief valve 90 with the low-pressure side of the hydraulic motor 24 regardless of whether the hydraulic motor 24 is driven in the first motor direction or the second motor direction. In certain examples, when the hydraulic drive system 20 is operated in the second mode, the second pressure relief setting of the second relief valve 90 can be increased (e.g., under the control of the controller 28) to provide braking of the hydraulic motor 24 (see FIG. 5).

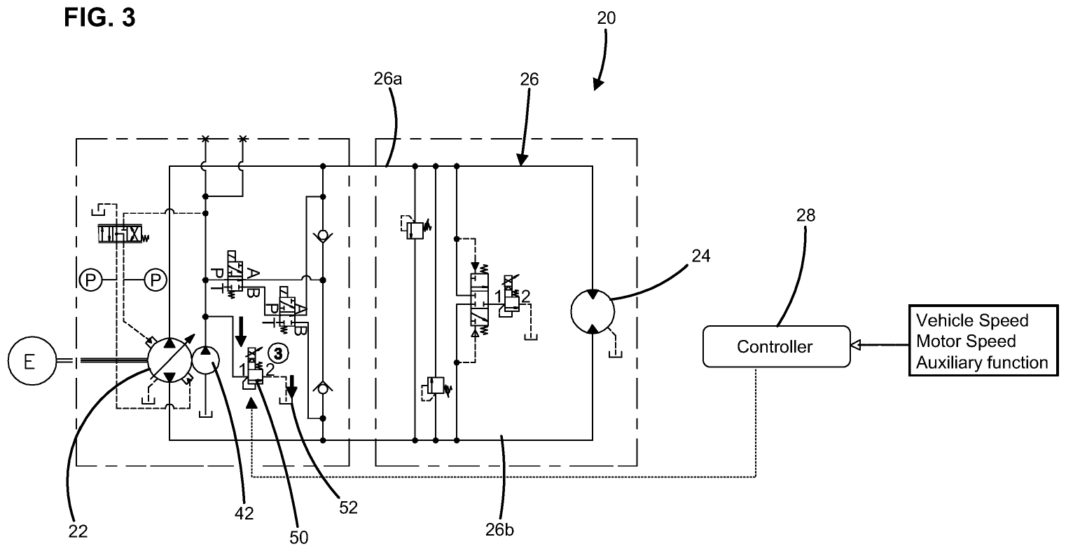

Referring to FIG. 3, the hydraulic drive system 20 is also operable in a third mode corresponding to an idling condition of the hydraulic motor 24. It will be appreciated that during an idling condition, the main hydraulic pump 22 would generally be set to zero displacement. It will be appreciated that the controller 28 can detect when the hydraulic drive system 20 is in an idling condition by detecting the stoppage of flow through the closed hydraulic circuit 26 or by other sensing means. When the controller 28 detects the idling condition, the first relief valve 50 can be set by the controller 28 to a third pressure relief setting that is lower than the first pressure relief setting. In the third pressure relief setting, hydraulic fluid flow from the charge pump 52 is dumped to tank with minimal resistance from the first relief valve 50 such that energy losses are minimized during idling conditions. When the hydraulic drive system 20 is in an idling condition, it will be appreciated that the hydraulic pressure at the first and second portions 26a, 26b of the closed hydraulic circuit 26 are generally equal, and the shuttle valve 92 is oriented at a closed position where the second relief valve 90 is disconnected from the closed hydraulic circuit 26. During an idling condition, the charge pump 52 charges the first and second portions 28a, 28b of the enclosed hydraulic circuit 26 to a level equal to the third pressure relief setting of the first relief valve 50. Thus, once the first and second portions 26a, 26b of the closed hydraulic circuit 26 are pressurized to the level of the third pressure relief setting, subsequent flow from the charge pump 42 is relieved to tank through the first relief valve 50.

Referring to FIG. 4, the hydraulic drive system 20 can further include one or more pressure sensors 94 (e.g., pressure transducers) for sensing and monitoring the pump control pressure in the pump control lines 32, 34. During operation of the hydraulic drive system 20 in the first mode, the pump control pressure is determined by the pressure within the closed hydraulic circuit 26 at the low-pressure side of the closed hydraulic circuit 26. When the hydraulic drive system 20 is operating in the first mode, the charge pump 42 provides charge flow to the low pressure side of the closed hydraulic circuit 26 thus influencing the pressure at the low pressure side of the closed hydraulic circuit 26 and also influencing the control pressure at the flow line 32, 34 in fluid communication with the low pressure side of the closed hydraulic circuit 26. In a preferred example, during operation of the hydraulic drive system 20 in the first mode, the first pressure relief setting of the second relief valve 90 is a variable and is dependent upon the pump control pressure sensed by the pressure sensors 94. The controller 28 preferably controls the first pressure relief setting of the second relief valve 90 based upon the sensed pump control pressure. For example, controller 28 can control the first pressure relief setting of the second relief valve 90 such that the first pressure relief setting is maintained at a predetermined amount greater than the sensed pump control pressure. Preferably, the first pressure relief setting established by the controller 28 is only a relatively small amount greater than the sensed pump control pressure so as to minimize loss during operation in the first mode. In certain examples, while the hydraulic drive system 20 is operated in the first mode, the first pressure relief setting of the first relief valve 50 is variable and is dependent upon the first pressure relief setting of the second relief valve 90. In certain examples, first pressure relief setting of the first relief valve 50 is controlled by the controller 28 so as to be greater than the first pressure relief setting of the second relief valve 90.

The controller 28 is used to control the hydraulic proportional valves 50, 90 and other valves (e.g., pump control valve 30, mode selector valve 54, directional flow valve 56). The controller also interfaces with pressure sensors, user interfaces, electric motor controls, and other components to operate the hydraulic circuit architectures in the various modes described above. The controller will have digital and/or analog inputs and outputs for interfacing with the sensors, valves and other components.

FIG. 2 shows the hydraulic drive system 20 operating in the second mode. To operate the system 20 in the second mode, the controller 28 de-strokes the main pump 22 (e.g., via valve 30), sets the first pressure relief valve 50 to its second pressure relief setting, sets the second pressure relief valve 90 to its second pressure relief setting, moves the mode selector valve 54 to its second position and sets the directional control valve 56 to a position for driving the hydraulic motor 24 in the desired direction. As shown at FIG. 2, the charge pump 42 draws hydraulic fluid from tank 52. Flow from the charge pump 42 flows through the mode selector valve 54 and the directional control valve 56 to the upper portion 26a of the closed circuit 26. Flow then proceeds through the hydraulic motor 24, to the lower portion 26b of the closed circuit 26, through the shuttle valve 92 and the second relief valve 90 back to tank. If the directional control valve 56 were to be in it other position, flow would proceed from valve 56 to the lower portion 26a, through the motor 24 to the upper portion 26b, and though the shuttle valve 92 and the second relief valve 90 to tank 52.

FIG. 4 shows the system 20 operating in the first mode. In this mode, the system operates as a closed loop circuit with flow rate and direction controlled by the controller 28 through control of the pumping direction and stroke length of the main pump 22 via actuation of control valve 30. When the system is operated in the first mode, the flow circulates around the closed circuit path 26 between the pump 22 and the motor 24, with charge flow 25 being provided by the charge pump 42 through flow line 58. Due to thermal expansion of the hydraulic fluid, some hydraulic fluid is passed through shuttle valve 92 and relief valve 90 to tank 52. The controller 28 adjusts the first pressure relief setting of the second relief valve 90 in real time to remain slightly higher than the pump control pressure as measured by pressure sensor 94. The first pressure relief setting of the first relief valve 50 is adjusted in real time by the controller 28 to be higher than the first pressure relief setting of the second relief valve 90.

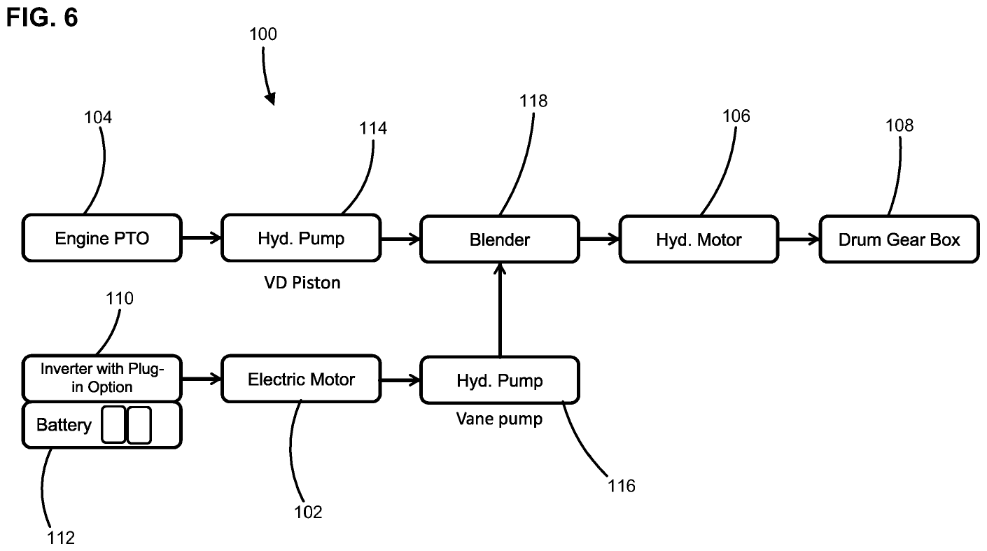

FIG. 6 schematically depicts a hydraulic drive system 100 which controls the delivery of power generated by an electric motor 102 and a combustion engine 104 to hydraulic motor 106 coupled to a gear box 108 which drives rotation of a concrete drum of a transit mixer. The electric motor 102 can be driven by an inverter 110 powered by a battery 112. Similar to the hydraulic drive system 20, the hydraulic drive system 100 includes a main hydraulic pump 114 and a charge pump 116 which cooperate with one another through the use of a blender 118 which is representative of hydraulic architecture of the type disclosed at FIG. 1 for allowing the system to be operated in a closed circuit mode (e.g., see FIG. 4) and an open circuit mode (see FIG. 2). The main hydraulic pump 114 is power by the combustion engine 104. In one example, the main hydraulic pump 114 is mounted on a power take-off of the combustion engine 104. The charge pump 116 is driven by the electric motor 102. The preferred architecture uses electric power to drive the charge pump 116 through electric motor 102 which is controlled by driver (inverter 110). The speed of the electric motor 102 can be varied and kept optimal based on the power requirement for the output to reduce losses in the hydraulic circuit during low speed requirement. The speed requirement to be computed in the controller based on the algorithm designed for specific application.

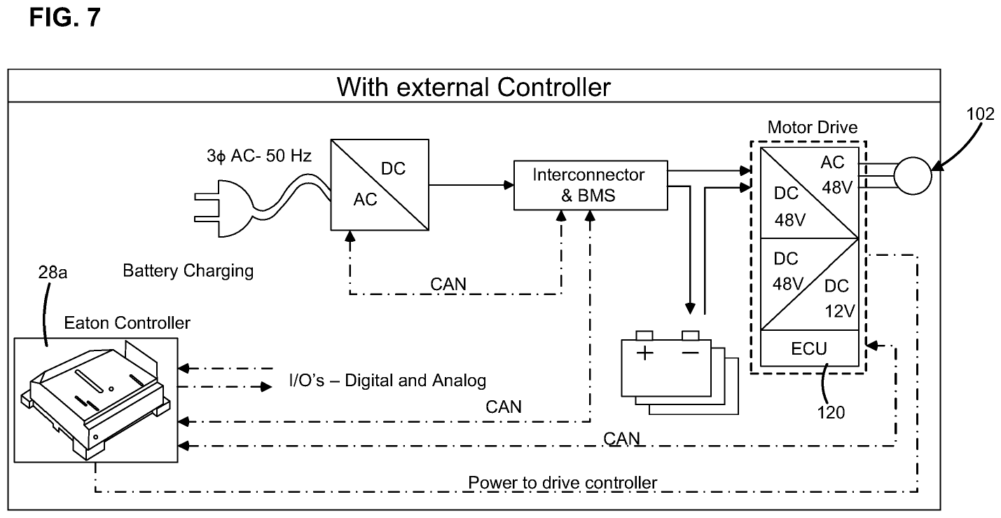

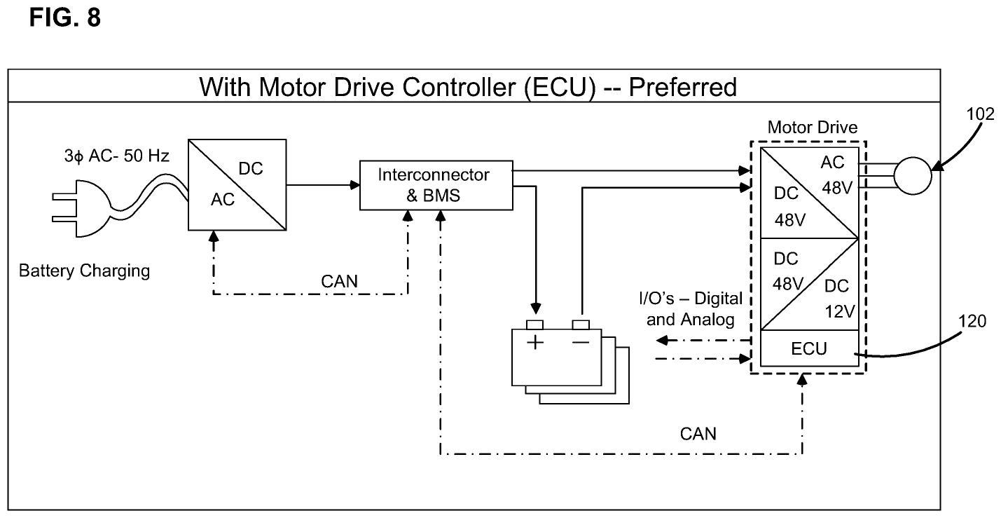

FIG. 7 shows a control system for the hydraulic drive system 100. The control system has a separate controller 28a which interfaces with the various pressure relief valves, solenoid valves, and sensors of the system. The controller 28a also interfaces with an electronic control unit 120 of the electric motor 102, and can include CAN communication for communication with battery management system (BMS) and the charger to take appropriate action based on the charging state of the battery. Deaccession/computation on controller may include: (1) Action based on low battery, full charge, state of charge etc.; and (2) Modification in the hydraulic circuit in case of low battery power to increase available range by activating main hydraulic pump (pump on PTO) during low speed operation while traveling (this can be achieved with same circuit by activating the valve appropriately, it may impact the traction force, however purpose can be solved in case of low battery power available). FIG. 8 shows a control system where the electronic control unit 120 of the electric motor is used to provide all control functionality for the hydraulic drive system 100.

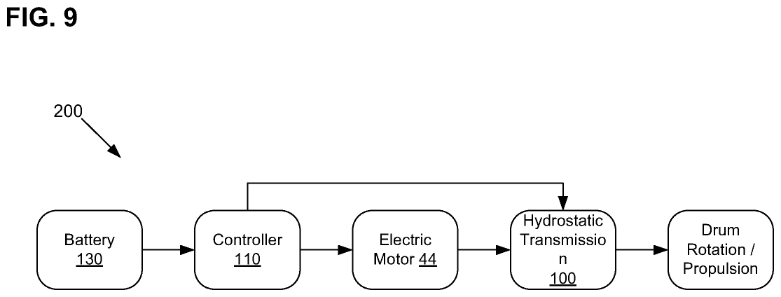

With reference to FIGS. 9 to 12, additional configurations are presented which can incorporate the hydraulic drive system 100 operating in the closed circuit mode. In some implementations, two hydraulic drive systems 100 can be utilized to provide power for the propulsion and drum functions of the vehicle, for example a transit mixer. In one aspect, the hydraulic drive system 100 can also be characterized as a hydrostatic transmission 100. The latter term is used with respect to the following description of FIGS. 9 to 12.

### Drive System 200

As shown at FIG. 9, a drive system 200 is presented in which the hydrostatic transmission 100 is driven by the electric motor 44 which is in turn powered by a battery 130 and operated by a controller 110 to effectuate drum rotation, propulsion, or any other rotary motion. In one aspect, the controller 110 may be configured with a converter/inverter.

In order to achieve different speeds of drum rotation, the speed of the electric motor 44 and the displacement of the hydraulic pump 22 is varied in such a way that the overall efficiency of the system is always maximum. For example, in a condition where high drum speed is desired, the hydraulic pump 22 and the hydraulic motor 24 used in hydrostatic transmission 100 works with full stroke displacement. During this time, the electric motor 44 should be operated at speed with maximum efficiency. Electric motor 44 draws power from battery 130 through controller 110 and performs the high speed drum rotation function.

Where a low drum speed is desired, the decision to either reduce the speed of electric motor 44 speed or de-stroking the hydraulic pump 22 used in hydrostatic transmission 100 will be based on the reference efficiency maps used in controller 110 such that maximum possible efficiency results. If the efficiency of the electric motor 44 at low speeds is higher than the efficiency of the hydraulic pump 22 at de-stroked conditions, then the controller 110 reduces the speed of the electric motor 44 in order to achieve the low speed drum rotation. If the efficiency of the electric motor at low speeds is lower than the efficiency of the hydraulic pump 22 at de-stroked conditions, then the controller 110 reduces the displacement of the hydraulic pump 22 in order to achieve the low speed drum rotation.

During battery powered drum rotation, the controller 110 receives the feedback of drum rotation speed, for example from a sensor or data input from the vehicle control system, and compares it with a reference speed derived from operator inputs and inverter output waveform. If the drum rotation speed matches the reference speed, the controller 110 stops the supply of power to electric motor 44. Once the drum rotation speed falls below the reference speed, then again controller 110 starts supplying power to electric motor 44.

### Drive System 300

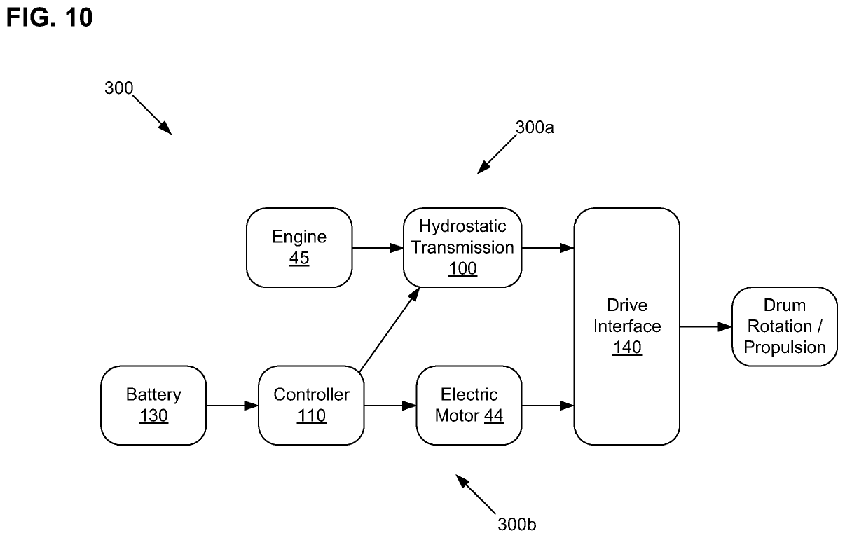

As shown at FIG. 10, a drive system 300 is presented in which parallel drive pathways 300a, 300b are provided to effectuate drum rotation or propulsion via a drive interface 140. With such a configuration, the first drive pathway 300a includes the hydrostatic transmission 100 and the engine 45 of the vehicle, wherein the engine 45 drives the hydrostatic transmission 100 to provide a first input to the drive interface 140 to effectuate drum rotation and/or propulsion. The second drive pathway 300b includes the battery 130, controller 110, and electric motor 44, wherein the battery 130 powers the electric motor 44 to provide a second input to the drive interface 140 to effectuate drum rotation and/or propulsion.

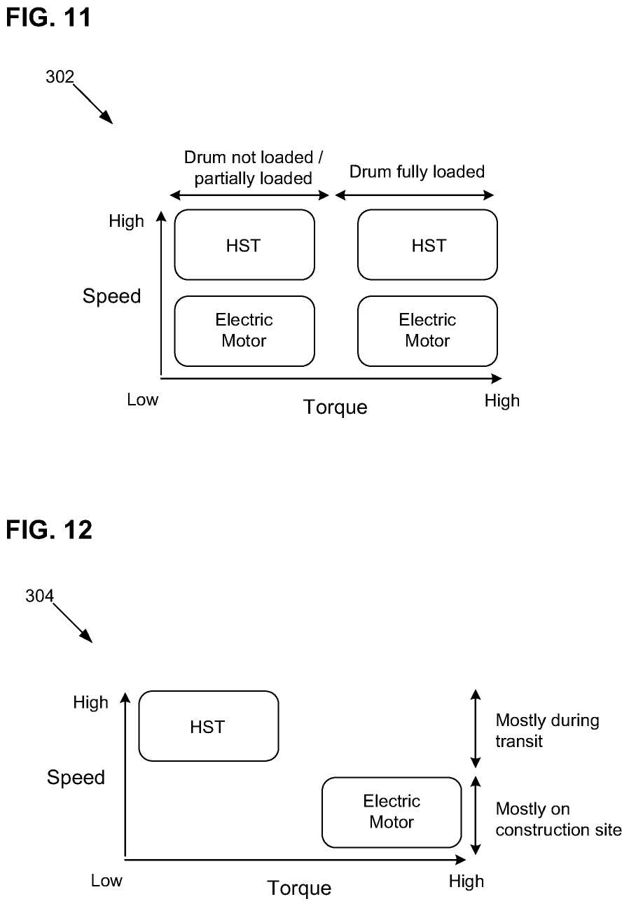

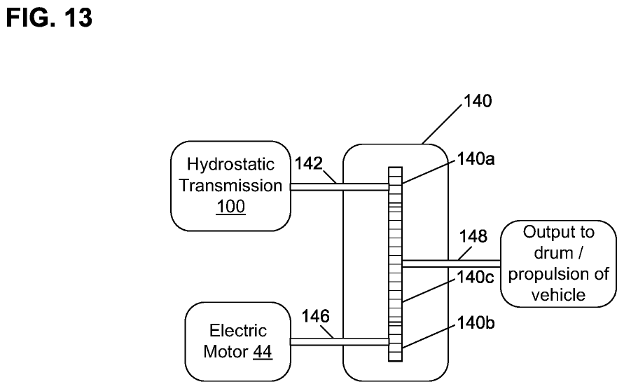

The drive interface 140 can be configured in any suitable form, such as a direct gear train, a planetary gear set, a belt-pulley drive system, etc. An example drive interface 140 is presented at FIG. 13 and shows a first gear 140a coupled to a drive shaft 142 associated with the hydrostatic transmission motor 24, a second gear coupled to a drive shaft 146 of the electric motor 44, and a third gear 140c engaged with the first and second gears 140a, 140b. An output shaft 148 is coupled to the third gear 140c and can be coupled with a component of the vehicle, for example the drum or the propulsion system. In the example shown, the rotation of either shaft 142, 146 causes the opposite rotation of the other shaft 142, 146 and the motor 44 and hydrostatic transmission 100 are configured such that their respective shafts 142, 146 rotate in the same direction to provide power to the output shaft 148. Accordingly, only of the hydrostatic transmission 100 and the electric motor 44 can provide power to the output shaft 148 at any given moment. Other configurations are possible. For example, the drive system 140 can be configured such that the hydrostatic transmission 100 and the electric motor 44 can simultaneously provide power to the output shaft 148 through conventional gearing arrangements. As mentioned previously, a planetary gear arrangement is also possible. Clutches may also be provided at one or both of the shafts 142, 146.

Where the drive system 300 is configured for drum rotation, the decision whether to use engine power via pathway 300a or battery power via pathway 300b for drum rotation is based on the speed requirements derived from operator input and the efficiency maps of hydrostatic transmission 100 and electric motor 44. With reference to FIG. 11, an example map 302 showing the mode selection based on speed and torque demands for the drum rotation is shown in which high-speed rotation of the drum is effectuated by the hydrostatic transmission 100, including low and high torque conditions resulting from loading of the drum. Map 302 also shows the selection of the electric motor 44 for all low-speed rotation conditions of the drum, including low and high torque conditions. Other configurations are possible without departing from the concepts presented herein. For example, high-speed drum rotation could be effectuated by the electric motor 44 and the low-speed rotation could be effectuated by the hydrostatic transmission 100.

For high speed requirements of drum rotation derived from operator input, the control logic in the controller 110 uses engine power transferred through hydrostatic transmission 100. During this time, the controller 110 disconnects power to electric motor 44. In an example configuration where the electric motor 44 and hydrostatic transmission 100 are directly coupled to the drive interface 140 with the gear arrangement shown at FIG. 13, the electric motor 44 works as a generator and supplies the charge to battery 130 through the inverter/converter associated with the controller 110.

When the controller 110, derives the low speed drum rotation requirements based on operator input, the hydrostatic transmission 100 stops transferring power to drum rotation shaft 148 by de-stroking variable displacement motor 24 and pump 22. This allows shaft 142 to rotate with as little resistance as possible while the while the electric motor 44 supplies power to the output shaft 148 via drive interface 140.

During battery powered low speed drum rotation, the controller 110 receives the feedback of drum rotation speed and compares it with the reference speed derived from operator input. If the drum rotation speed matches the reference speed, the inverter of the controller 110 stops the supply of power to electric motor 44 during which the electric motor 44 would rotate due to the drum inertia. During this, the electric motor 44 works as a generator and electric charge/current generated flows from electric generator 44 to the battery 130 through the inverter/converter of the controller 110. When drum rotation speed drops below the reference speed in controller 110, then the inverter of the controller 110 again starts supplying power to electric motor 44 from battery 130.

Where the drive system 300 is configured for vehicle propulsion, the decision whether to use engine power via pathway 300a or battery power via pathway 300b for drum rotation is based on the speed requirements derived from operator input and the efficiency maps of hydrostatic transmission 100 and electric motor 44. With reference to FIG. 12, an example map 304 showing mode selection based on speed and torque demands for propulsion is shown. In one aspect, high-speed propulsion, typically associated with low torque demands, is effectuated by the electric motor 44 and while low-speed propulsion, typically associated with higher torque demands, is effectuated by the hydraulic transmission 100. Other configurations are possible without departing from the concepts presented herein.

For low speed requirements of propulsion derived from operator input, the control logic uses engine power transferred through hydrostatic transmission 100. During this time controller 110 disconnects power to electric motor 44 and electric motor 44 works as a generator and supplies the current to battery 130.

When the controller 110, derives the high speed propulsion requirements based on operator input, the hydraulic transmission 100 stops transferring power to propulsion by de-stroking variable displacement motor 24 and pump 22. And then controller 110, supplies the electric power for propulsion using electric motor 44.

During battery powered high speed propulsion (mostly during constant speed mode with pedal-on), the controller 110 receives the feedback of propulsion speed and compares it with the reference speed derived from operator command and inverter output waveform. If the propulsion speed matches the reference speed, the inverter of the controller 110 stops the supply of power to electric motor 44 during which the electric motor 44 would rotate due to the kinetic inertia (kinetic regeneration) of the vehicle. During this, the electric motor 44 works as the generator and electric charge/current generated flows from electric generator 44 to the battery 130 through the inverter/converter of the controller 110. When propulsion speed drops below the reference speed in controller 110, then the inverter of the controller 110 again starts supplying power to electric motor 44 from battery 130.

During battery powered propulsion when the operator is not engaging pedal (pedal-off) and not yet applied the dynamic braking, the inverter is not supplying electric power as there is no operator command through pedal. During this, electric motor 44 works as a generator 44 due to vehicle kinetic inertia and electric current generated flows from generator 44 to battery 130 through inverter/converter device associated with the controller 110 to effectuate regenerative braking.

In one aspect of the above-referenced regeneration process, the controller 110 recognizes the constant speed requirement based on the operator pedal angle/input which is constant over the period of time. Once the controller 110 recognizes the constant speed mode, if the propulsion speed has matched the reference speed in the controller, then the controller 110 stops the power supply to electric motor 44 even though the operator is pressing the pedal at constant angle/input. During the period of power supply cut-off the electric motor 44 acts as a generator 44. During this, if propulsion speed falls below the reference speed, then again the power supply to electric motor 44 is resumed. During when constant speed mode is ON, if there is any change in pedal movement/angle, then this pedal movement input overrides the condition of constant speed mode and propulsion speed is regulated as per the operator input through pedal.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A hydraulic drive system comprising:
a main hydraulic pump;
a hydraulic actuator;
a charge pump;
the hydraulic drive system being operable in a first mode in which the main hydraulic pump drives the hydraulic actuator via a closed hydraulic circuit and the charge pump provides charge flow to the closed hydraulic circuit; and the hydraulic drive system also being operable in a second mode in which the charge pump drives the hydraulic actuator via an open hydraulic circuit.

2. The hydraulic drive system of claim 1, wherein in the second mode the main hydraulic pump is set to zero displacement and the charge pump alone drives the hydraulic actuator via the open hydraulic circuit.

3. The hydraulic drive system of claim 1, further comprising a first relief valve for limiting an output pressure of the charge pump by fluidly connecting an output side of the charge pump to tank when the output pressure of the charge pump reaches a charge pump relief pressure level, wherein the charge pump relief pressure level of the first relief valve is set at a first pressure relief setting when the hydraulic drive system is operated in the first mode and a second pressure relief setting when the hydraulic drive system is operated in the second mode, and wherein the second pressure relief setting of the first relief valve is higher than the first pressure relief setting of the first relief valve.

4. The hydraulic drive system of claim 1, further comprising a second relief valve adapted to be in fluid communication with a low pressure side of the hydraulic actuator for limiting an oil pressure at the low pressure side of the hydraulic actuator, wherein the second relief valve is set at a first pressure relief setting when the hydraulic drive system is operated in the first mode and a second pressure relief setting when the hydraulic drive system is operating in the second mode, and wherein the first pressure relief setting of the second relief valve is higher than the second pressure relief setting of the second relief valve.

5. The hydraulic drive system of claim 4, wherein the second relief valve relieves hydraulic fluid from the closed hydraulic circuit to tank to prevent hydraulic pressure within the closed hydraulic circuit from exceeding the first pressure relief setting of the second relief valve when the hydraulic fluid within the closed hydraulic circuit thermally expands when the hydraulic drive system is operated in the first mode, and wherein the second relief valve allows hydraulic fluid from the low pressure side of the actuator to by-pass the main pump and flow instead to tank when the hydraulic drive system is operated in the second mode and the second relief valve is set at the second pressure relief setting of the second relief valve.

6. The hydraulic drive system of claim 5, further comprising a mode selector valve moveable between a first position in which the hydraulic drive system is configured such that the charge pump is adapted to provide charge flow to the closed hydraulic circuit and a second position in which the hydraulic drive system is configured such that the charge pump is adapted to drive the hydraulic actuator.

7. The hydraulic drive system of claim 6, further comprising a flow directional control valve in fluid communication with the mode selector valve for controlling a direction of hydraulic fluid flow through the hydraulic actuator such that the charge pump can selectively drive the hydraulic actuator in first and second opposite actuator directions.

8. The hydraulic drive system of claim 7, further comprising a shuttle valve for connecting the second relief valve in fluid communication with the low pressure side of the hydraulic actuator when the hydraulic actuator is driven in the first actuator direction and when the hydraulic actuator is driven in the second actuator direction.

9. The hydraulic drive system of claim 3, wherein the hydraulic drive system is operable in a third mode corresponding to an idling condition of the hydraulic actuator, wherein when the hydraulic drive system is operated in the third mode the first relief valve is set to a third pressure relief setting that is lower than the first pressure relief setting of the first relief valve.

10. The hydraulic drive system of claim 4, further comprising a pressure sensor for sensing a pump control pressure, and wherein the first pressure relief setting of the second relief valve is variable and is dependent upon the sensed pump control pressure.

11. The hydraulic drive system of claim 10, wherein the first pressure relief setting of the second relief valve is a predetermined amount greater than the sensed pump control pressure.

12. The hydraulic drive system of claim 10, wherein the first pressure relief setting of the first relief valve is variable and dependent upon the first pressure relief setting of the second relief valve.

13. The hydraulic drive system of claim 3, wherein when the hydraulic drive system is operated in the second mode, the second pressure relief setting of the second relief valve can be increased to provide braking of the hydraulic actuator.

14. The hydraulic drive system of claim 1, wherein the main hydraulic pump and the charge pump are driven by a single drive shaft rotated by a power source.

15. The hydraulic drive system of claim 1, wherein the main hydraulic pump and the charge pump are driven by a single power source.

16. The hydraulic drive system of claim 14, wherein the power source is a combustion engine or an electric motor.

17. The hydraulic drive system of claim 1, wherein the main hydraulic pump is driven by a first power source and the charge pump is driven by a second power source.

18. The hydraulic drive system of claim 17, wherein the first power source is a combustion engine and the second power source is an electric motor.

19. The hydraulic drive system of claim 1, further comprising a controller for receiving an input signal representative of a desired speed of the hydraulic actuator, and for automatically switching the system between the first and second mode dependent upon the desired speed.

20. The hydraulic drive system of claim 19, wherein the controller operates the system in the second mode when the desired speed is below a predetermined speed value, and operates the system in the first mode when the desired speed is above the predetermined speed value.

21. The hydraulic drive system of claim 20, wherein the controller interfaces with the first and second relief valves and is adapted to control the pressure relief settings of the first and second relief valves.

22. A hydraulic drive system for driving a vehicle component, the hydraulic drive system comprising:
an electric motor;
a variable displacement hydraulic pump driven by the electric motor;
a variable displacement hydraulic motor driven by the main hydraulic pump, the hydraulic motor having an output shaft for driving the vehicle component;
a controller for controlling the speed of the electric motor and the displacement of the hydraulic pump, the controller being configured to meet an output demand of the hydraulic motor by selecting a combination of motor displacement, pump displacement and motor speed that results in the maximum efficiency of the system.

23. The hydraulic drive system of claim 22, wherein the hydraulic component is one of a rotating drum and a propulsion system of a vehicle.

24. The hydraulic drive system of claim 22, wherein the controller is configured with a high speed mode and a low speed mode, wherein in the high speed mode the hydraulic motor and pump are operated at full displacement and the speed of the electric motor is varied to meet the output demand of the hydraulic motor.

25. The hydraulic drive system of claim 1, wherein if an efficiency of the electric motor at low speeds is higher than an efficiency of the hydraulic pump at de-stroked conditions, the controller reduces the speed of the electric motor in order to achieve the output demand of the hydraulic motor.

26. The hydraulic drive system of claim 1, wherein if an efficiency of the electric motor at low speeds is lower than an efficiency of the hydraulic pump at de-stroked conditions, the controller reduces the hydraulic pump displacement in order to achieve the output demand of the hydraulic motor.

27. The hydraulic drive system of claim 1, wherein the controller compares a rotational speed of the hydraulic component and compares the rotational speed with a reference speed, wherein the controller stops supply of power to the electric motor when the rotational speed matches the reference speed, wherein the controller supplies power to the electric motor when the rotational speed falls below the references speed.

28. A drive system for driving a vehicle component, the drive system comprising: a first drive pathway including a hydrostatic transmission;
a second drive pathway including an electric motor;
a drive interface for transmitting power from the first or second drive pathway to the vehicle component; and
a controller for selectively operating the hydrostatic transmission and the electric motor.

29. The drive system of claim 28, wherein the vehicle component is a drum of a transit mixer, the drum having a rotational speed demand.

30. The drive system of claim 29, wherein when a rotational speed demand of the drum is above a threshold, the controller operates the hydrostatic transmission to supply power to the vehicle component through the drive interface.

31. The drive system of claim 30, wherein the electric motor is driven by the hydrostatic transmission through the drive interface and acts as a generator.

32. The drive system of claim 29, wherein when a rotational speed demand of the drum is below a threshold, the controller operates the electric motor to supply power to the drum through the drive interface and controls the hydrostatic transmission to destroke each of a hydraulic pump and a hydraulic motor of the hydrostatic transmission.

33. The drive system of claim 29, wherein the controller compares a rotational speed of the drum and compares the rotational speed with a reference speed, wherein the controller stops supply of power to the electric motor when the rotational speed matches the reference speed, wherein the controller supplies power to the electric motor when the rotational speed falls below the references speed.

34. The drive system of claim 28, wherein the vehicle component is a propulsion system of a transit mixer, the propulsion system having a speed demand.

35. The drive system of claim 34, wherein when a rotational speed demand of the propulsion system is above a threshold, the controller operates the electric motor to supply power to the propulsion system through the drive interface and controls the hydrostatic transmission to destroke each of a hydraulic pump and a hydraulic motor of the hydrostatic transmission.

36. The drive system of claim 34, wherein when a rotational speed demand of the propulsion system is below a threshold, the controller operates the hydrostatic transmission to supply power to the vehicle component through the drive interface.

37. The drive system of claim 34, wherein the controller compares a rotational speed of the propulsion system and compares the rotational speed with a reference speed, wherein the controller stops supply of power to the electric motor when the rotational speed matches the reference speed, wherein the controller supplies power to the electric motor when the rotational speed falls below the references speed.

38. The drive system of claim 33, wherein when the controller stops supply of power to the electric motor when the rotational speed matches the reference speed, the electric motor operates as a generator due to the rotational inertia of the drum.

39. The drive system of claim 37, wherein when the controller stops supply of power to the electric motor when the rotational speed matches the reference speed, the electric motor operates as a generator.

40. The system of claim 1, wherein when the electric motor is powered by the battery for propulsion of the vehicle, the electric motor operates as a generator to effectuate regenerative braking when an operator is not engaging an accelerator of the vehicle and has not applied braking to the vehicle.
